(19) United States
(12) Patent Application Publication
(10) Pub. No.: US 2022/0192796 A1
(43) Pub. Date: Jun. 23, 2022

(54) LATERALLY EXPANDING DENTAL IMPLANT

(71) Applicant: Ahmad Rayan, Kabul (IL)

(72) Inventor: Ahmad Rayan, Kabul (IL)

(21) Appl. No.: 17/543,756

(22) Filed: Dec. 7, 2021

(30) Foreign Application Priority Data
Dec. 20, 2020 (IL) 279614

(51) Int. Cl. A61C 8/00

(52) U.S. Cl. CPC A61C 8/0033; A61C 8/0089

(57) ABSTRACT

A dental implant is designed to be fixed into an undercut socket in the bone. For example, an undercut socket may be drilled into the jawbone. Optionally, the undercut is produced using a T-slot milling bit. Optionally, the implant includes retractable protrusions. For example, the implant is inserted into the socket with the protrusions retracted and/or the protrusions are extended when they reach the undercut. For example, the protrusions may be biased outward (e.g., by a spring) and/or there may be tool (e.g., a screw that is inserted into the implant after it reaches the undercut) which causes the protrusions to extend.

### FIELD AND BACKGROUND OF THE INVENTION

The present invention, in some embodiments thereof, relates to a dental implant and, more particularly, but not exclusively, to an implant which can fixed more quickly in the jaw of patient.

US Patent Publication no. 20150313611 appears to disclose, “A bone cutting device for forming an undercut in bone. The device includes a rotatable body having an inner surface and outer surface. The inner surface defines an aperture. The inner and outer surfaces are disposed opposite each other and define a sidewall. The sidewall includes a recess extending from the outer surface into the aperture. A cutting arm is cantilevered to the sidewall and disposed within the recess. The cutting arm includes a flexible depression extending into the aperture. An actuating member is longitudinally slidable within the aperture such that sliding the actuating member longitudinally interfaces with the flexible depression and pushes the cutting arm radially outwardly.”

US Patent Publication no. 20200015873 appears to disclose, “An attachment device with a radially expandable section . . . ” “The attachment device can have helical threads, for example, to facilitate screwing the attachment device into a bone. Methods of using the same are also disclosed. The attachment device can be positioned to radially expand the expandable section in cancellous bone substantially surrounded by cortical bone.”

U.S. Pat. No. 6,117,161 appears to disclose, “A fastener comprising a longitudinally extending member having a hub region and at least two arms extending in a longitudinal direction from the hub region, the member defining a plane and having a length and a width less than the length, the arms each being provided with a sharp edge, the hub region being provided with an engaging member for receiving a rotational force about an axis perpendicular to the plane of the member for rotating the member in the plane of the member, the fastener adapted to be inserted in a longitudinally extending groove in an object to which the fastener is to be secured, the groove being at least coextensive with the length of the longitudinally extending member and having a width at least as large as the width of the member, the fastener being adapted to be rotated via the rotational force once inserted in the groove so that the sharp edges of the arms cut into sides of the grooves thereby forming undercuts securing the fastener in the object.”

U.S. Pat. No. 9,408,599 appears to disclose, “A method and apparatus for coupling a soft tissue implant into a locking cavity formed within a bone . . . ” “The method includes bringing a bone cutting tool extending along a longitudinal axis into engagement with an outer surface of the bone. The bone cutting tool is rotated about the longitudinal axis while driving it from the outer surface of the bone to a predetermined depth in the bone to form a bore. The bone cutting tool is then continuously rotated at the predetermined depth to establish an enlarged bone pocket at a distal end of the bore. The bone pocket defines a shoulder extending around a circumference between the bone pocket and bore. The bone cutting tool is removed from the bone pocket and bore. The fixation device is then inserted into the bone pocket through the bore, where it is seated against the bone pocket shoulder.”

U.S. Pat. No. 6,146,407 appears to disclose, “A suture anchor . . . ” “having a central shaft and at least one outwardly extending longitudinal rib. The ribs may have bone engaging elements such as threads or barbs on their outer surfaces. A bone boring tool having more than one set of sharpened cutting edges is described which creates a non-circular hole in bone approximating the anchor cross section geometry. The suture anchor is inserted into the shaped hole in bone and is rotated about its axis by the driver to engage the ribs with the bone.”

Additional background art includes US Patent Publication no. 20090149959, U.S. Pat. No. 5,268,001.

### SUMMARY OF THE INVENTION

According to an aspect of some embodiments of the invention, there is provided a dental implant including: a proximal mount configured for attachment to an abutment; an elongated body; a protrusion laterally extendible from the body of the implant.

According to some embodiments of the invention, the implant further includes a lock for prevent retraction of the protrusion.

According to some embodiments of the invention, the implant further includes a key configured to be inserted through the proximal mount into the lock for triggering at least one of triggering the lock to lock the protrusion in an extended position and to release the lock to allow retraction of the protrusion.

According to some embodiments of the invention, the implant further includes a key configured to be inserted through the proximal mount into the lock for triggering at least one of triggering the lock to lock the protrusion in an extended position.

According to some embodiments of the invention, the elongated body includes a longitudinal channel with internal threading and wherein the key includes an external threading configured to mesh with the internal threading of the longitudinal channel.

According to some embodiments of the invention, the key is configured to screw into the longitudinal channel until a distal portion of the key blocks a path of retraction of the protrusion preventing retraction thereof.

According to some embodiments of the invention, the elongated body includes a longitudinal channel and wherein the key includes a handle passing through the channel and a threading configured to connect to the protrusion, driving the protrusion when the key is rotated.

According to some embodiments of the invention, the protrusion projects from a distal portion of the implant.

According to some embodiments of the invention, the protrusion is extended by rotating around a hinge.

According to some embodiments of the invention, the implant further includes a key having an elongated head and wherein the head is configured to fit to a connector in the lock while a handle passes through a channel through the elongated body and where a state of the lock is changed by twisting the handle to twist the head and the connector.

According to an aspect of some embodiments of the invention, there is provided a kit for installing a dental implant including: a milling tool configured to cut an undercut socket into a jawbone; a dental implant including a proximal mount configured for attachment to an abutment, an elongated body and a protrusion laterally extendible from the body of the implant.

According to some embodiments of the invention, the protrusion is positioned and configured to fit into an undercut of the socket.

According to some embodiments of the invention, the implant further includes a lock for prevent retraction of the protrusion.

According to some embodiments of the invention, the kit further includes a key configured to be inserted through the proximal mount into the lock for triggering at least one of triggering the lock to lock the protrusion in an extended position and to release the lock to allow retraction of the protrusion.

According to some embodiments of the invention, the elongated body includes a longitudinal channel and wherein the key includes a handle passing through the channel and a threading configured to connect to the protrusion, driving the protrusion when the key is rotated.

According to some embodiments of the invention, the kit further includes a key configured to be inserted through the proximal mount into the lock for triggering at least one of triggering the lock to lock the protrusion in an extended position.

According to some embodiments of the invention, the elongated body includes a longitudinal channel with internal threading and wherein the key includes an external threading configured to mesh with the internal threading of the longitudinal channel.

According to some embodiments of the invention, the key is configured to screw into the longitudinal channel until a distal portion of the key blocks a path of retraction of the protrusion preventing retraction thereof.

According to some embodiments of the invention, the protrusion is extended by rotating around a hinge.

According to some embodiments of the invention, the implant further includes a key having an elongated head and wherein the head is configured to fit to a connector in the lock while a handle passes through a channel through the elongated body and where a state of the lock is changed by twisting the handle to twist the head and the connector.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWING(S)

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a block diagram illustration of an implant with a retractable protrusion in accordance with an embodiment of the current invention;

FIG. 2 is a block diagram illustration of an implant with a lock and retractable protrusions in accordance with an embodiment of the current invention;

FIG. 3 is a block diagram illustration of an implant with a key and retractable protrusions in accordance with an embodiment of the current invention;

FIG. 4 is a block diagram illustration of an implant with a key, a lock and retractable protrusions in accordance with an embodiment of the current invention;

FIG. 5 is a block diagram of an implant in a socket in accordance with an embodiment of the current invention;

FIG. 6 is a flow chart illustration of inserting an implant in accordance with an embodiment of the current invention;

FIG. 7 is a flow chart illustration of inserting an implant an undercut socket in accordance with an embodiment of the current invention;

FIG. 8 is a flow chart illustration of adjusting an implant in accordance with an embodiment of the current invention;

FIG. 9 is a schematic perspective view of an implant with a channel and retractable protrusions in accordance with an embodiment of the current invention;

FIG. 10 is a schematic cross-sectional view of an implant with a channel and retractable protrusions in accordance with an embodiment of the current invention;

FIG. 11 is a schematic cross-sectional view of a bone socket with an undercut in accordance with an embodiment of the current invention;

FIG. 12 is a schematic perspective view of a T Slotting Mill in accordance with an embodiment of the current invention;

FIG. 13 is a schematic perspective view of an implant head in accordance with an embodiment of the current invention;

FIG. 14 is a schematic perspective view of an implant with retractable protrusions in accordance with an embodiment of the current invention;

FIG. 15 is a schematic cross-sectional view of an implant with retractable protrusions in accordance with an embodiment of the current invention; and

FIG. 16 is a schematic perspective view of a key in accordance with an embodiment of the current invention.

### DESCRIPTION OF SPECIFIC EMBODIMENTS OF THE INVENTION

The present invention, in some embodiments thereof, relates to a dental implant and, more particularly, but not exclusively, to an implant which can fixed more quickly in the jaw of patient.

### Overview

An aspect of some embodiments of the current invention relates to a dental implant including an extendable lateral protrusion configured for anchoring the implant into a socket in a jawbone. Optionally, the implant includes a lock configured to hold the protrusions in an extended position. For example, there may be a channel in the implant and/or a lock that is inserted into the channel until it blocks a path of retraction of the protrusion. Alternatively or additionally, a key may be insertable into a channel in the implant to release a lock and/or facilitate retraction of the protrusion and/or release of the implant from the socket. Optionally, the implant may have one or more extendable protrusions. For example, there may be two or more protrusions. Optionally, protrusions may extend in opposing directions.

In some embodiments, a socket in a jawbone may include an undercut. For example, the undercut may be in a distal portion of the socket and/or the lateral protrusion may extend from a distal portion of the implant. For example, the protrusion may protrude from the distal ½ of the implant and/or the distal ¼ and/or the distal ⅛ of the implant. Optionally, the portion of the implant not including the protrusion may have a fixed width. Optionally the length of the implant is fixed. In some embodiments, the length of an implant may range between 1 to 10 mm and/or between 1 to 5 cm. In some embodiments, the width of an implant may range between 1 to 3 mm and/or between 3 to 20 mm and/or between 20 to 50 mm. Optionally, the body of the implant may include an external screw thread. For example, the thread may be used to screw the implant into a bone socket.

In some embodiments, an implant may be anchored into a jawbone by extending one or more lateral protrusions. For example, the protrusions may expand outward into an undercut in the socket. Alternatively or additionally, the protrusions may expand outward and create a force against a wall of the socket. Optionally, the protrusion will stabilize the implant in the socket and/or allow attaching of an abutment and/or a prosthesis to the implant with reduced and/or no waiting for bone growth.

In some embodiments, the implant may include a head configured for attachment to an abutment. For example, the head may include an internal hexagon and/or a conical connector and/or an external hexagon. Optionally, the implant will include an elongated body. For example, the body may include an external screw thread. For example, the implant may be screwed in to a socket in a jawbone.

An aspect of some embodiments of the current invention relates to a kit for inserting an implant into a jawbone. For example, the kit may include an implant having an extendable protrusion and/or a tool for forming an undercut socket in the jawbone. For example, the tool may include an undercut bit and/or a drill guide. For example, the bit may include a T slot cutter.

### Specific Embodiments

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

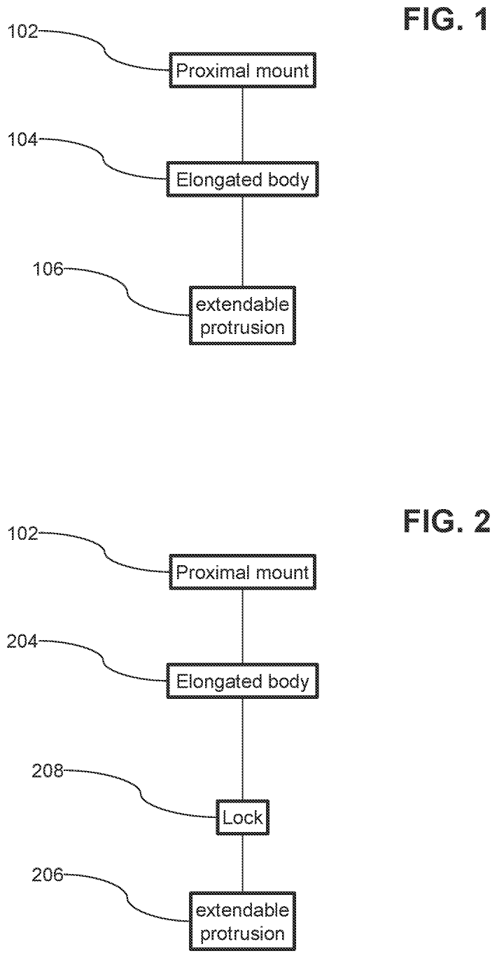

FIG. 1 is a block diagram illustration of an implant with a retractable protrusion in accordance with an embodiment of the current invention. In some embodiments, a dental implant includes an elongated body 104 having and extendable protrusion 106. For example, the protrusion 106 may be extendable and/or retractable laterally from the body 104 of the implant. For example, the protrusion 106 may protrude from a distal portion of the implant. In some embodiments, a proximal portion of the implant may include a mount 102 configured for connection to a dental abutment and/or a prosthesis. For example, the mount may be on a proximal portion (e.g., proximalmost ½ and/or proximalmost 3

FIG. 2 is a block diagram illustration of an implant with a lock and retractable protrusions in accordance with an embodiment of the current invention. In some embodiments, a dental implant includes an elongated body 204 having and extendable protrusion 206. For example, the protrusion 206 may be extendable and/or retractable laterally from the body 204 of the implant. For example, the protrusion 206 may protrude from a distal portion of the implant. Optionally, a lock 208 may hold the protrusion 206 in an extended position. For example, in the extended position, the protrusion 206 may hold the fast to a socket in a jawbone. For example, a protrusion 206 may press against a wall of the socket and/or the protrusion 206 may extend into an undercut in the socket e.g., to prevent removal of the implant from the socket and/or to stabilize the implant in the socket. Alternatively or additionally, a lock 208 may keep the protrusion 206 in a retracted position until released, for example, while the implant is being inserted into the socket. For example, lock 208 may be wedged behind protrusion 306 pushing the protrusion 206 into the extended position and/or retaining it in the extended position. For example, a lock 208 may be pushed and/or screwed into a channel through the body 204 of the implant until it wedges behind the protrusion 206.

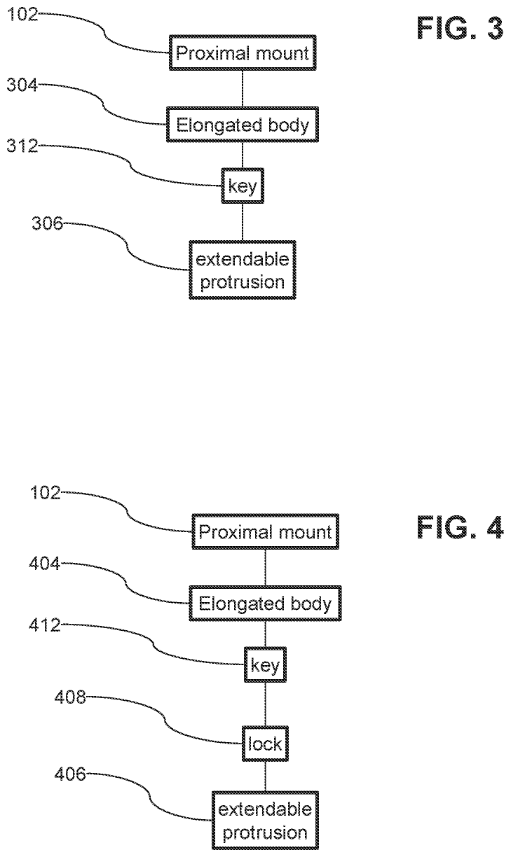

FIG. 3 is a block diagram illustration of an implant with a key 312 and retractable protrusion 306 in accordance with an embodiment of the current invention. In some embodiments, key 312 is used to activate and/or deactivate a lock, for example to extend protrusion 306 and/or secure protrusion 306 in an extended position. Optionally, the key 312 may be elongated and/or accessible from outside the channel.

FIG. 4 is a block diagram illustration of an implant with a key 412, lock 408 and retractable protrusion 406 in accordance with an embodiment of the current invention. In some embodiments a key 412 may be configured to lock or unlock a lock 408. For example, key 412 may be used to shift a lock 408 to between a locked and/or an unlocked position. For example, an elongated key may be inserted through a channel in the implant and/or used to manipulate a lock 408. For example, a lock may include a piece that is wedged behind a protrusion locking it into an extended position. Optionally the lock is pushed and/or manipulated (e.g., twisted and/or screwed) with the key (for example an Alan head screw driver and/or Alan wrench or the like). For example, unlocking lock 408 may allow movement of protrusion 406 from a retracted state to an extended state and/or unlocking lock 408 may allow movement of protrusion 406 from an extended state to a retracted state.

In some embodiments, the protrusion 306, 406 may be extendable and/or retractable laterally from the body 304, 404 of the implant. For example, the protrusion 306, 406 may protrude from a distal portion of the implant. Optionally, in the extended position, the protrusion 306, 406 may hold the fast to a socket in a jawbone. For example, a protrusion 306, 406 may press against a wall of the socket and/or the protrusion 306, 406 may open into an undercut in the socket e.g., to prevent removal of the implant from the socket and/or to stabilize the implant in the socket. Alternatively or additionally, a lock 408 and/or a key 312 may keep the protrusion 306, 406 in a retracted position until released, for example, while the implant is being inserted into the socket.

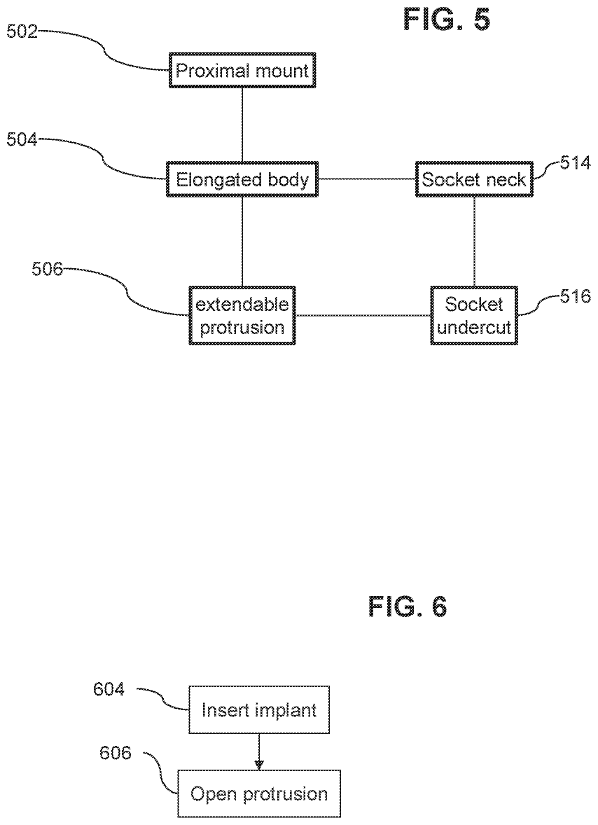

FIG. 5 is a block diagram of an implant in a socket in accordance with an embodiment of the current invention. An implant (for example as described in any of the embodiments herein e.g., having an elongated body 504 and/or extendable lateral protrusions 506 and/or a key and/or a lock) may be fitted to a socket in a jaw. For example, the socket may have an elongated neck 514 and/or an undercut 516. Optionally the protrusion 506 of the implant may be positioned and/or configured to extend into the undercut. For example, an elongated body 504 of the implant may be screwed, wedged and/or slipped into the socket neck. Optionally, the protrusion 506 is positioned on the body 504 of the implant to reach the undercut 516 when the implant is positioned in the socket. For example, the protrusion 506 may be positioned on a distal portion of the body 504 of the implant. Optionally, the mount 502 is positioned on the body 504 of the implant to be accessible from an opening of the socket. For example, the mount 502 may be positioned on a proximal portion and/or proximal end of the implant.

FIG. 6 is a flow chart illustration of inserting an implant in accordance with an embodiment of the current invention. In some embodiments, an implant is inserted 604 for example, into a socket in a jawbone. For example, the implant may be screwed into the socket and/or wedged into the socket and/or slid into the socket. Optionally, one or more protrusions are opened 606, e.g., to fix the implant into the socket. For example, the protrusion may be opened laterally outward from the body of the implant. Optionally, the socket may include an undercut and/or the protrusion may be opened 606 into the undercut.

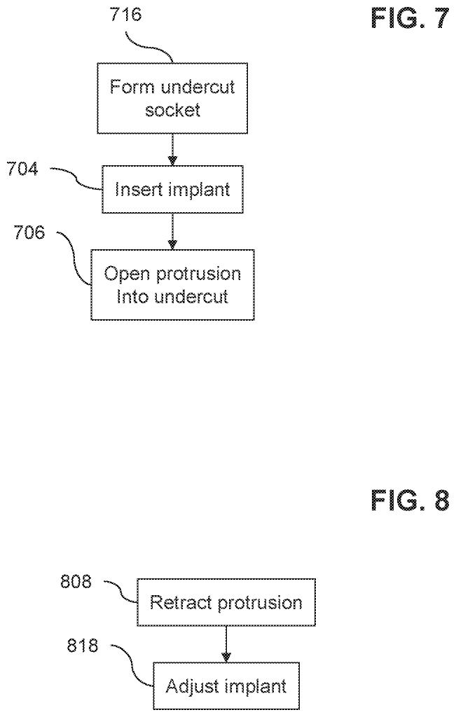

FIG. 7 is a flow chart illustration of inserting an implant an undercut socket in accordance with an embodiment of the current invention. In some embodiments, a socket is formed 716 in a jawbone of a patient with an undercut. For example, the socket may be drilled into the jawbone and/or the undercut may be milled into the socket. Optionally the insert is inserted 704 into the socket. For example, the implant may be screwed into the socket and/or wedged into the socket and/or slid into the socket. In some embodiments, while the implant is inserted 704 into the socket, one or more extendable protrusions are retracted. In some embodiments, after the implant has been inserted 704 into the socket, one or more extendable protrusions are extended 706. For example, the protrusions may be extended 706 laterally outward from the body in the undercut in the socket. For example, the protrusions may be extended by a key and/or a biasing mechanism and/or any means described herein. Optionally, the extended protrusions will anchor the implant in the jawbone and/or facilitate attaching an abutment and/or a prosthesis to the implant more quickly than conventional implants that are anchored by bone growth and/or take relative a long time to achieve anchoring in the bone.

FIG. 8 is a flow chart illustration of adjusting an implant in accordance with an embodiment of the current invention. In some embodiments, one or more extendable protrusions may be retracted 808 facilitating adjusting 818 (e.g., moving and/or removing) a position of the implant. For example, retracting 808 the protrusions may be achieved by removing a key and/or opening a lock with a key for example as illustrated in any of the embodiments disclosed herein. For example, a key may be removed from the implant releasing and/or facilitating retraction of the protrusions and/or a key may be used to manipulate a lock and/or unlock the protrusions.

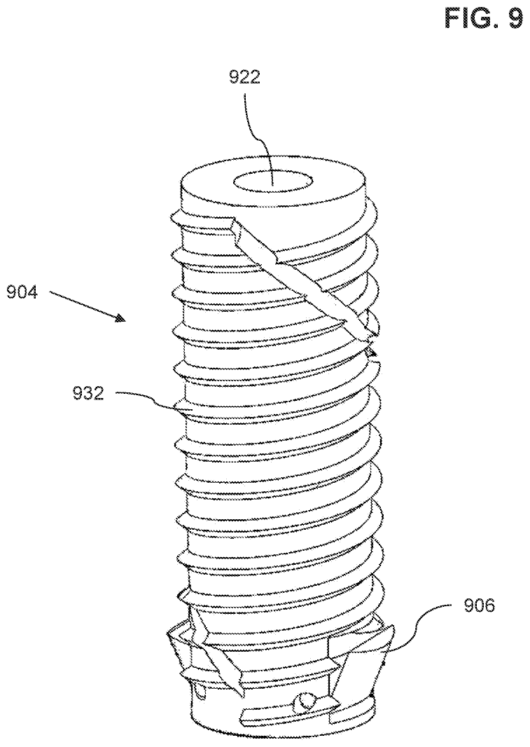

FIG. 9 is a schematic perspective view of an implant with a channel and retractable protrusions in accordance with an embodiment of the current invention. In some embodiments, an implant includes an elongated body 904 with an internal longitudinal channel 922. Optionally, extendable protrusions 906 are included on distal portion of the implant. For example, the protrusions 906 may pivot lateral outward from the body 904 of the implant. Optionally, a distal portion of the protrusions 906 is pivotally connected to the body 904 of the implant such that the proximal part of the protrusion 906 pivots outward. For example, when the protrusions 906 pivot out, they may form a distally pointed barb which may catch on a wall of a socket and/or a sill of an undercut if the implant is pulled proximally out of the socket and/or the undercut.

In some embodiments, the implant includes a hollow channel 922 through the core thereof. Optionally, a pin and/or a screw is inserted into the channel. For example, when a distal portion of the pin reaches a distal portion of the implant, forces it pushes protrusions 906 outward. For example, a tapered pin may be pushed into channel 922. When the tapered portion of the pin reaches the space between the protrusions, it takes up the space between the protrusion 906 and/or pushes out protrusions 906. Optionally, the pin may be shorter than the channel 922 and/or may reside in a distal portion of the channel 922. For example, withing the distamost ½ and/or ¼ and/or ⅛. Additionally or alternatively, the channel (e.g., a proximal portion thereof) may be used for attaching an abutment screw e.g., to hold an abutmet to the head of the implant. Optionally, protrusions 906 may engage a wall of a socket and/or hook into a socket in the socket, anchoring the implant. Anchoring the implant may facilitate mounting an abutment and/or a prosthesis onto the implement without needing to wait for bone to grow and/or affix the implant. In some embodiments, an implant may include an external thread 932.

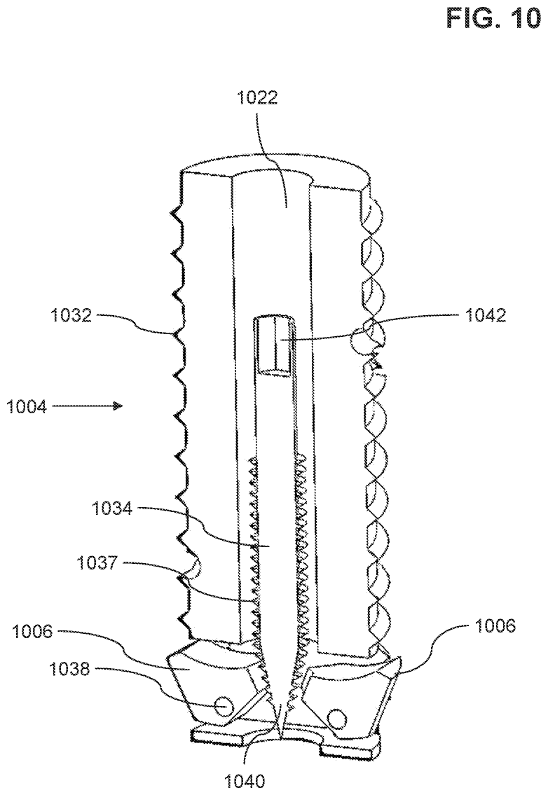

FIG. 10 is a schematic cross-sectional view of an implant with a channel and retractable protrusions in accordance with an embodiment of the current invention. In some embodiments, extendable protrusions 1006 are connected via a hinge 1038 to a body 1004 of the implant. For example, rotation of the protrusion 1006 around the hinge 1038 causes the protrusion 1006 to extend laterally from the implant and/or retract towards the implant. Optionally, a lock 1034 is located in a distal portion of an inner channel 1022 of the implant. For example, the lock may include a screw with external threading 1037. In some embodiments, the threading 1037 of the lock 1034 is coupled to the protrusions 1006. For example, the lock 1034 may be fixed in a channel 1022 through the implant and/or twisting the screw may cause the threads 1037 to drive an inner portion of the protrusions 1006 up or down (e.g., depending on direction of rotation of the lock 1034) thereby rotating protrusions 1006 around hinge 1038 and/or extending or retracting the protrusions. Alternatively or additionally, thread 1037 of lock 1034 may be coupled to the channel 1022 such that rotating lock 1034 causes the lock 1034 to move in a distal direction or proximal direction in the channel 1022 (depending on the direction of rotation). Movement of the lock 1034 in the channel 1022 pushes a tapered head 1040 of the screw between the protrusions, pushing them and causing them to rotate around hinges 1038 and/or extend or retract laterally. In some embodiments, the lock includes a socket 1042 (e.g., a hexagonal Allen socket). For example, a key (e.g., an Allen key) may be inserted into channel 1022 to connect to socket 1042 and/or rotate lock 1034 and/or extend or retract protrusions 1006. Optionally, the implant includes an elongated body 1004 with an external screw thread 1032. For example, the implant may be screwed into a socket in a jaw bone and/or the protrusions 1006 may be extended to lock the implant into the bone. Optionally, the protrusions 1006 may be retracted to remove and adjust the position of the extensions. In some embodiments, the lock 1034 may reside in a distal portion of the channel 1022. Optionally, the proximal portion of the channel 1022 and/or a proximal end of the implant may be used for mounting an abutment and/or a prosthesis to the implant. For example, the proximal end of the implant may include a fitting (for example a hexagonal protrusion and/or a hexagonal socket) for mounting to an abutment and/or the proximal portion of channel 1022 may be threaded to attach to an abutment screw).

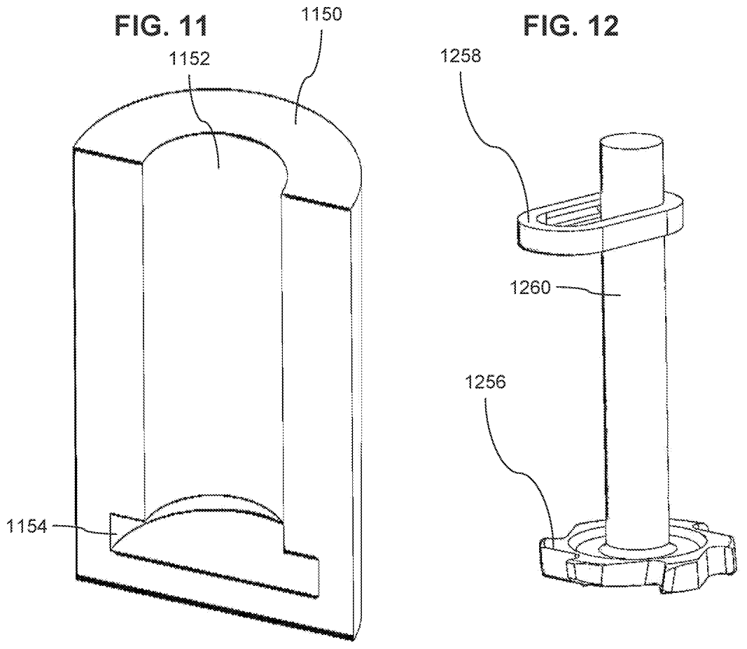

FIG. 11 is a schematic cross-sectional view of a bone socket with an undercut in accordance with an embodiment of the current invention. A socket in a jaw bone 1150 optionally includes an elongated cylindrical neck 1152 and an optional undercut 1154. For example, the undercut 1154 may be in a distal portion of the socket. For example, the undercut 1154 is optionally positioned such that when the implant is inserted therein and the protrusions extended, the protrusions will enter the undercut 1154 and/or lock the implant in the socket.

FIG. 12 is a schematic perspective view of a T Slotting Mill in accordance with an embodiment of the current invention. In some elements. In some embodiments, a t-slotting mill 1256 is used to cut an undercut in a cylindrical socket. For example, a cylindrical hole large enough to fit the cutting head of the mill 1256 is drilled and/or milled into the jaw. Optionally, the mill 1256 is inserted therein and a groove is made in a distal portion of the hole. For example, the T slotting mill 1256 may be moved around the edges of the hole. Optionally, the position of the mill 1256 is controlled using a guide 1258. For example, while the cutting head of the mill 1256 is in a distal portion of the socket a shank 1260 of the mill moves within the guide causing the cutting head to cut a groove around the edges of the socket. Alternatively or additionally, other tools may be used to form an undercut. For example, a drill bit may include an extendable tooth.

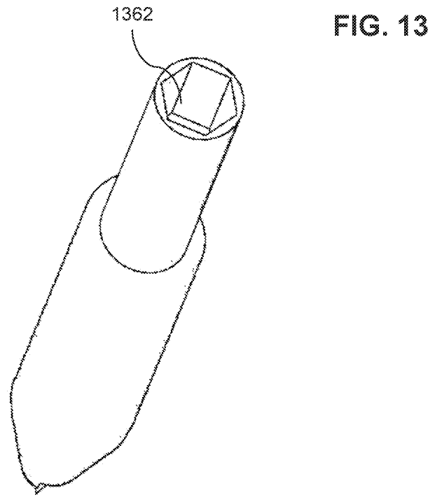

FIG. 13 is a schematic perspective view of an implant head in accordance with an embodiment of the current invention. In some embodiments, a proximal end of the implant includes a conventional mount for an abutment. For example, the mount may include a hexagonal socket 1362 and/or an underlying threaded channel for an abutment screw to hold the abutment in place. Optionally, a lock for the extendable protrusions is locked deep inside the channel where it does not interfere with the abutment screw.

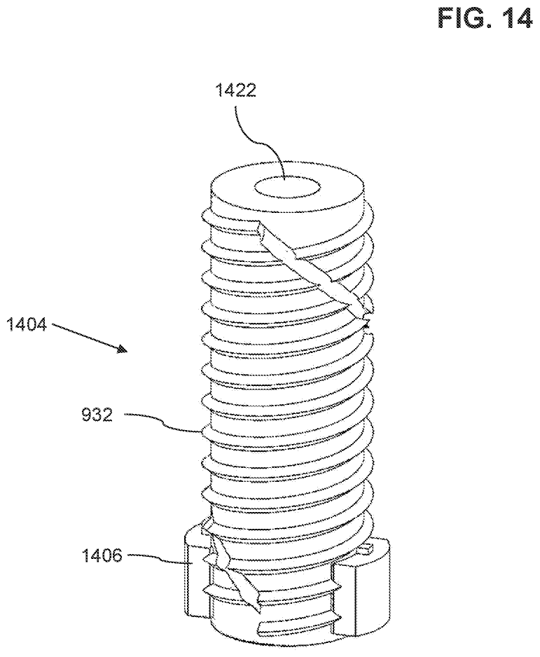

FIG. 14 is a schematic perspective view of an implant with retractable protrusions in accordance with an embodiment of the current invention. In some, embodiments, a protrusion 1406 may extend linearly. For example, protrusions 1406 may slide laterally outward from the side walls of an elongated cylindrical body 1404 of the implant. For example, the protrusions may be spring loaded (e.g., biased outward and/or inward). Optionally, a lock and/or key may be supplied. For example, the lock may be opened and/or closed using a key fitting through a channel 1422 running longitudinally through the implant.

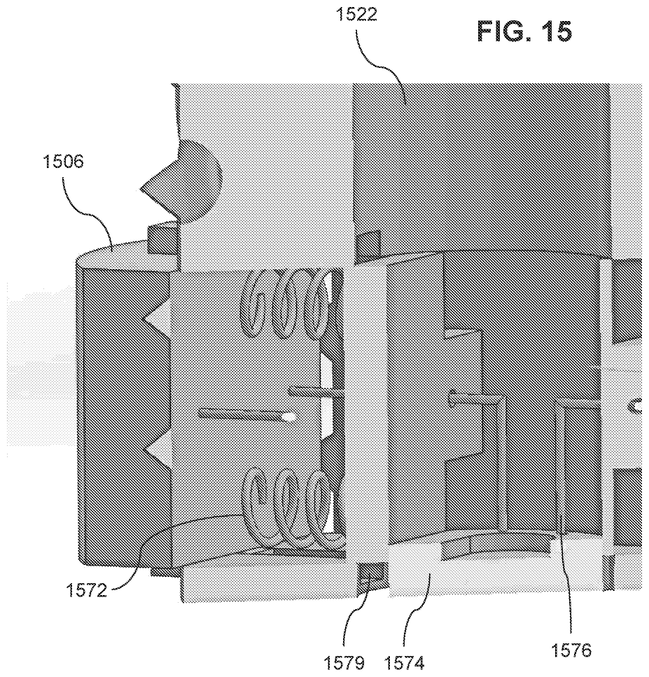

FIG. 15 is a schematic cross-sectional view of a lock of an implant with retractable protrusions in accordance with an embodiment of the current invention. For example, the lock of FIG. 15 may be used in the implant of FIG. 14. For example, elastic elements (e.g., springs 1572) may bias protrusions 1506 laterally outward. Optionally, a mechanism is supplied to retract the protrusions 1506. For example, twisting floor 1574 and/or pushing floor 1574 optionally puts tension on cables 1576 and/or pulls protrusions 1506 inward. Twisting the floor 1574 in the opposite direction releases protrusion 1506 to extend outward. Alternatively or additionally, pushing floor 1574 downward slides the sides of floor 1574 into slots 1579 facilitating protrusions 1506 collapsing inward. For example, collapsing protrusions 1506 inward may facility adjusting, moving and/or removing the implant from a socket. For example, the locking mechanism may have a movable floor 1574. Optionally, the floor is connected to the protrusions 1506 by a cable 1576. For example, a key including a long rod is pushed into a channel 1522 through the implant and is used to push the floor 1574 downward and/or rotate floor 1574.

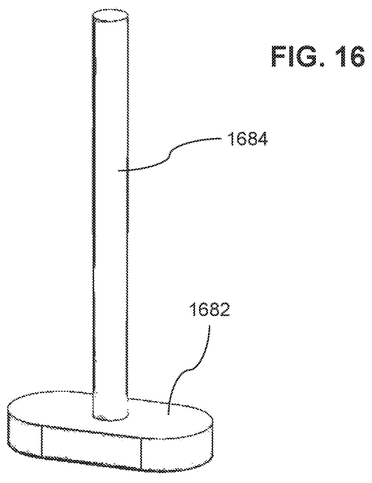

FIG. 16 is a schematic perspective view of a key in accordance with an embodiment of the current invention. For example, a key may have a distal head 1682 which connects to floor 1574 while an elongated handle 1684 protrudes through channel 1522. For example, a user threads the head 1682 through channel 1522 into an indentation in floor 1574 and/or twists the proximal part of handle 1684 which extends out of channel 1522 to twist floor 1574 to extend or retract protrusions 1506.

It is expected that during the life of a patent maturing from this application many relevant technologies will be developed and the scope of the terms are intended to include all such new technologies a priori.

As used herein the term “about” refers to ±10%

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween. When multiple ranges are listed for a single variable, a combination of the ranges is also included (for example the ranges from 1 to 2 and/or from 2 to 4 also includes the combined range from 1 to 4).

As used herein the term “method” refers to manners, means, techniques and procedures for accomplishing a given task including, but not limited to, those manners, means, techniques and procedures either known to, or readily developed from known manners, means, techniques and procedures by practitioners of the chemical, pharmacological, biological, biochemical and medical arts.

As used herein, the term “treating” includes abrogating, substantially inhibiting, slowing or reversing the progression of a condition, substantially ameliorating clinical or aesthetical symptoms of a condition or substantially preventing the appearance of clinical or aesthetical symptoms of a condition.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A dental implant comprising:
a proximal mount configured for attachment to an abutment;
an elongated body;
a protrusion laterally extendible from said body of the implant.

2. The implant of claim 1, further comprising a lock for prevent retraction of said protrusion.

3. The implant of claim 2, further comprising a key configured to be inserted through said proximal mount into said lock for triggering at least one of triggering said lock to lock said protrusion in an extended position and to release said lock to allow retraction of the protrusion.

4. The implant of claim 2, further comprising a key configured to be inserted through said proximal mount into said lock for triggering at least one of triggering said lock to lock said protrusion in an extended position.

5. The implant of claim 3, wherein said elongated body includes a longitudinal channel with internal threading and wherein said key includes an external threading configured to mesh with said internal threading of said longitudinal channel.

6. The implant of claim 5, wherein said key is configured to screw into said longitudinal channel until a distal portion of said key blocks a path of retraction of said protrusion preventing retraction thereof.

7. The implant of claim 3, wherein said elongated body includes a longitudinal channel and wherein said key includes a handle passing through the channel and a threading configured to connect to said protrusion, driving said protrusion when said key is rotated.

8. The implant of claim 1, wherein said protrusion projects from a distal portion of said implant.

9. The implant of claim 1, wherein said protrusion is extended by rotating around a hinge.

10. The implant of claim 2, further comprising a key having an elongated head and wherein said head is configured to fit to a connector in the lock while a handle passes through a channel through said elongated body and where a state of the lock is changed by twisting said handle to twist said head and said connector.

11. A kit for installing a dental implant comprising:
a milling tool configured to cut an undercut socket into a jawbone;
a dental implant including a proximal mount configured for attachment to an abutment, an elongated body and a protrusion laterally extendible from said body of the implant.

12. The kit of claim 11, wherein said protrusion is positioned and configured to fit into an undercut of said socket.

13. The kit of claim 11, wherein said implant further includes a lock for prevent retraction of said protrusion.

14. The kit of claim 13, further comprising a key configured to be inserted through said proximal mount into said lock for triggering at least one of triggering said lock to lock said protrusion in an extended position and to release said lock to allow retraction of the protrusion.

15. The implant of claim 14, wherein said elongated body includes a longitudinal channel and wherein said key includes a handle passing through the channel and a threading configured to connect to said protrusion, driving said protrusion when said key is rotated.

16. The kit of claim 13, further comprising a key configured to be inserted through said proximal mount into said lock for triggering at least one of triggering said lock to lock said protrusion in an extended position.

17. The kit of claim 14, wherein said elongated body includes a longitudinal channel with internal threading and wherein said key includes an external threading configured to mesh with said internal threading of said longitudinal channel.

18. The kit of claim 17, wherein said key is configured to screw into said longitudinal channel until a distal portion of said key blocks a path of retraction of said protrusion preventing retraction thereof.

19. The implant of claim 11, wherein said protrusion is extended by rotating around a hinge.

20. The implant of claim 13, further comprising a key having an elongated head and wherein said head is configured to fit to a connector in the lock while a handle passes through a channel through said elongated body and where a state of the lock is changed by twisting said handle to twist said head and said connector.
